(19) United States
(12) Patent Application Publication
(10) Pub. No.: US 2025/0191350 A1
(43) Pub. Date: Jun. 12, 2025

(54) IMAGE PROCESSING DEVICE AND IMAGE PROCESSING METHOD

(71) Applicant: Panasonic Intellectual Property Management Co., Ltd., Osaka (JP)

(72) Inventor: Takeshi WATANABE, Kanagawa (JP)

(73) Assignee: Panasonic Intellectual Property Management Co., Ltd., Osaka (JP)

(21) Appl. No.: 18/845,325

(22) PCT Filed: Jan. 30, 2023
(86) PCT No.: PCT/JP2023/002836

§ 371 Date: Sep. 9, 2024

(30) Foreign Application Priority Data
Mar. 11, 2022 (JP) 2022-037831

(51) Int. Cl. G06V 10/776; G06T 5/50; G06T 5/60; G06V 10/22

(52) U.S. Cl. CPC G06V 10/776; G06T 5/50; G06T 5/60; G06V 10/235; G06V 2201/07

(57) ABSTRACT

Provided is an image processing device or method configured to enable a system developer or a system administrator to easily and visually check robustness of a machine learning model against various possible environmental changes on site to thereby build a system with high robustness. In the image processing device or method, a processor performs information processing operations which include, in response to a user's operation to designate an image processing condition, performing an image processing operation on an original image based on the designated image processing condition, generating a simulated image that reproduces an image captured in a specific situation, generating a heat map (status image) that represents a status of recognition of a detection target, and overlaying the heat map on the simulated image to produce a result image as a result of visualization, which is output as display information.

### TECHNICAL FIELD

The present disclosure relates to an image processing device and an image processing method in which, when an image recognition operation that uses a machine learning model is performed for detecting a predetermined event from a captured image, a status of recognition of a detection target is visualized and presented to a user so that the user can visually check image recognition performance of the machine learning model.

### BACKGROUND ART

Monitoring systems that are widely used include systems for detecting a predetermined event occurred in a monitored area by performing an image recognition operation on images of the monitored area captured by a camera. In recent years, the accuracy of image recognition has been dramatically improved by using a machine learning model constructed using machine learning technologies such as deep learning.

When a machine learning model is used for image recognition, the machine learning model is a black box; that is, a process in the machine learning model to produce a recognition result is unknown, which means that a user cannot easily check image recognition performance of the machine learning model. Known technologies addressing this problem in image recognition using a machine learning model, include a technology that visualizes a basis for determinations made by a machine learning model to produce a recognition result, with images and texts (Patent Document 1).

### PRIOR ART DOCUMENT(S)

### Patent Document(s)

Patent Document 1: JP2019-82883A

### SUMMARY OF THE INVENTION

### Task to be Accomplished by the Invention

In the above prior art technology for image recognition using a machine learning model, a basis for determinations made by a machine learning model to produce a result of image recognition is visualized and displayed with images and texts, which enables a user to easily visually check a process in the machine learning model to produce a result of image recognition.

However, environmental changes may cause diverse changes in the conditions of a monitored area. In such cases, an image recognition operation that uses a machine learning model may also be affected by environmental changes, resulting in reduced accuracy. Therefore, it is not sufficient to evaluate the recognition performance of a machine learning model with the use of images captured under a specific condition, and there is a need for a technology to evaluate the recognition performance of a machine learning model with the use of images captured under various conditions caused by environmental changes; that is, a technology to allow a system developer or a system administrator to check whether or not the robustness of image recognition that uses a machine learning model, against various possible environmental changes on site is sufficient.

The present disclosure has been made in view of the problem of the prior art, and a primary object of the present disclosure is to provide an image processing device and an image processing method that enable a system developer or a system administrator to easily and visually check robustness of a machine learning model against various possible environmental changes on site to thereby build a system with high robustness.

### Means to Accomplish the Task

An aspect of the present disclosure provides an image processing device for performing processing operations to visualize a status of recognition of a detection target when performing an image recognition operation that uses a machine learning model for detecting a predetermined event from a captured image, wherein the processing operations are performed by a processor, and include: in response to a user's operation to designate an image processing condition, performing an image processing operation on an original image based on the designated image processing condition to thereby generate a simulated image that reproduces an image captured in a specific situation; and generating a status image that represents a status of recognition of a detection target, when performing the image recognition operation on the simulated image, and overlaying the generated status image on the simulated image to produce a result image as a result of visualization, which is output as display information.

Another aspect of the present disclosure provides an image processing method for performing processing operations to visualize a status of recognition of a detection target when performing an image recognition operation that uses a machine learning model for detecting a predetermined event from a captured image, wherein the processing operations are performed by an information processing device, and the processing operations include: in response to a user's operation to designate an image processing condition, performing an image processing operation on an original image based on the designated image processing condition to thereby generate a simulated image that reproduces an image captured in a specific situation; and generating a status image that represents a status of recognition of a detection target when performing the image recognition operation on the simulated image, and overlaying the generated status image on the simulated image to produce a result image as a result of visualization, which is output as display information.

### Effect of the Invention

According to the present disclosure, an image processing operation based on an image processing condition that is designated by a user is used to generate a simulated image that reflects various possible environmental changes on site. When an image recognition operation is performed on the simulated image, a status image that represents a status of recognition of a detection target is generated, and the status image is overlaid on the simulated image to produce a result image as a result of visualization, which is output as display information. This configuration enables a system developer or a system administrator to easily and visually check robustness of a machine learning model against various possible environmental changes on site to thereby build a system with high robustness.

### BRIEF DESCRIPTION OF THE DRAWINGS

FIG. 1 is a diagram showing an overall configuration of a robustness check system according to one embodiment of the present disclosure;

FIG. 2 is an explanatory diagram showing an outline of operations performed by an image processing device;

FIG. 3 is a block diagram showing a schematic configuration of the image processing device;

FIG. 4 is a block diagram showing an outline of operations performed by the image processing device;

FIG. 5 is an explanatory diagram showing an original image setting screen;

FIG. 6 is an explanatory diagram showing a detection target setting screen;

FIG. 7 is an explanatory diagram showing a processing condition setting screen;

FIG. 8 is an explanatory diagram showing a simulated image display screen;

FIG. 9 is an explanatory diagram showing a visualization result screen;

FIG. 10 is an explanatory diagram showing the visualization result screen;

FIG. 11 is an explanatory diagram showing another example of the visualization result screen;

FIG. 12 is an explanatory diagram showing a procedure for calculating a validity score;

FIG. 13 is an explanatory diagram showing a real-time visualization result screen;

FIG. 14 is an explanatory diagram showing the visualization result screen when a plurality of detection targets are designated;

FIG. 15 is an explanatory diagram showing a visualization result screen of a second example of when a plurality of detection targets are designated;

FIG. 16 is an explanatory diagram showing another visualization result screen of the second example of when a plurality of detection targets are designated; and

FIG. 17 is a flow chart showing a procedure of operations of the image processing device.

### DESCRIPTION OF THE PREFERRED EMBODIMENT(S)

A first aspect of the present disclosure made to achieve the above-described object is an image processing device for performing processing operations to visualize a status of recognition of a detection target when performing an image recognition operation that uses a machine learning model for detecting a predetermined event from a captured image, wherein the processing operations are performed by a processor, and include: in response to a user's operation to designate an image processing condition, performing an image processing operation on an original image based on the designated image processing condition to thereby generate a simulated image that reproduces an image captured in a specific situation; and generating a status image that represents a status of recognition of a detection target, when performing the image recognition operation on the simulated image, and overlaying the generated status image on the simulated image to produce a result image as a result of visualization, which is output as display information.

According to this configuration, an image processing operation based on an image processing condition that is designated by a user is used to generate a simulated image that reflects various possible environmental changes on site. When an image recognition operation is performed on the simulated image, a status image that represents a status of recognition of a detection target is generated, and the status image is overlaid on the simulated image to produce a result image as a result of visualization, which is output as display information. This configuration enables a system developer or a system administrator to easily and visually check robustness of a machine learning model against various possible environmental changes on site to thereby build a system with high robustness.

A second aspect of the present disclosure is the image processing device of the first aspect, wherein the processing operations performed by the processor include: presenting a detection target setting screen to the user; and in response to the user's operation on the detection target setting screen, setting the detection target designated by the user.

This configuration enables a user to check recognition statuses of various detection targets by changing the detection target designated from among various types of detection targets. The detection target may be an object of a specific type or a specific state of an object of a specific type.

A third aspect of the present disclosure is the image processing device of the first aspect, wherein the processing operations performed by the processor include: presenting a processing condition setting screen to the user; and in response to the user's operation on the processing condition setting screen, setting the image processing condition designated by the user.

This configuration enables generation of simulated images that reproduce the images captured under various environmental conditions which may cause a loss of accuracy expected in a monitored area, thereby ensuring that a user can check the robustness of a machine learning model against environmental changes.

A fourth aspect of the present disclosure is the image processing device of the first aspect, wherein the image processing operation includes at least one of a blurring operation, an illuminance adjusting operation, and a virtual object overlaying operation.

In this configuration, the blurring operation enables generation of a simulated image that reproduces, for example, an image captured when the camera lens is fogged up or an image captured when there is a fog out of doors. The illuminance adjusting operation enables generation of a simulated image that reproduces, for example, an image captured under strong sunlight, or an image captured under low sunlight and with lighting devices unlit. The virtual object overlaying operation enables generation of a simulated image that represents a situation of a monitored area in which the monitored area is crowded with persons, or a simulated image that represents a situation of the monitored area in which an object as a detection target is hidden by another object, for example.

A fifth aspect of the present disclosure is the image processing device of the first aspect, wherein the processing operations performed by the processor include: generating a tone image, in which a color tone at each part of the simulated image represents a contribution degree which is a degree to which the each part accounts for a recognition result of the image recognition operation; and overlaying the tone image as the status image on the simulated image.

This configuration enables a user to properly grasp the status of recognition of a detection target in the image recognition operation. The tone image may be an image in which a color tone (hue) at each part of a subject image gradually changes depending on the “contribution degree”, which is a degree to which the each part accounts for a recognition result indicating an object detected in the image recognition operation, or a monochromatic image in which a level of brightness (density) at each part of a subject image gradually changes depending on the contribution degree of the each part.

A sixth aspect of the present disclosure is the image processing device of the first aspect, wherein the processing operations performed by the processor include: generating a score image indicating a score that numerically expresses an accuracy of the status of recognition of the detection target in the simulated image; and overlaying the score image as the status image on the simulated image.

This configuration enables a user to easily grasp an accuracy of the status of recognition of the detection target on the simulated image, i.e., a validity of a machine learning model for the simulated image. The accuracy of a status of recognition of a detection target on a simulated image can be quantified, for example, based on the degree of consistency between an area of the detection target in the simulated image and the area of the status image overlaid on the simulated image.

A seventh aspect of the present disclosure is the image processing device of the first aspect, wherein, when the user designates a plurality of detection targets, the processing operations performed by the processor include: generating the status image for each of the plurality of detection targets such that the respective status images for the plurality of detection targets are shown in a visually distinguishable manner; and overlaying the status images on the simulated image.

This configuration enables a user to visually grasp the status of recognition of each of the detection targets. In this case, for example, the status images for the detection targets may be simultaneously displayed in different forms, specifically in different colors or patterns. A detection target(s) for which the status images are overlaid on the simulated image may be changed in response to a user's operation on the screen to select a type of detection target by using selection tabs displayed on the screen.

An eighth aspect of the present disclosure is an image processing method for performing processing operations to visualize a status of recognition of a detection target when performing an image recognition operation that uses a machine learning model for detecting a predetermined event from a captured image, wherein the processing operations are performed by an information processing device, and the processing operations include: in response to a user's operation to designate an image processing condition, performing an image processing operation on an original image based on the designated image processing condition to thereby generate a simulated image that reproduces an image captured in a specific situation; and generating a status image that represents a status of recognition of a detection target when performing the image recognition operation on the simulated image, and overlaying the generated status image on the simulated image to produce a result image as a result of visualization, which is output as display information.

This configuration enables a system developer or a system administrator to easily and visually check robustness of a machine learning model against various possible environmental changes on site to thereby build a system with high robustness, in the same manner as the first aspect.

Embodiments of the present disclosure will be described below with reference to the drawings.

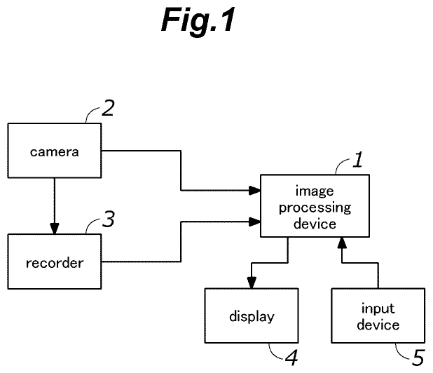

FIG. 1 is a diagram showing an overall configuration of a robustness check system according to one embodiment of the present disclosure.

The system includes an image processing device 1 (information processing device), a camera 2, and a recorder 3.

The camera 2 captures images of a monitored area. The recorder 3 stores images captured by the camera 2. The image processing device 1 receives real-time captured images from the camera 2. The image processing device 1 also receives the captured images stored in the recorder 3.

The image processing device 1 consists primarily of a personal computer (PC) or similar device. Connected to the image processing device 1 are a display 4 and an input device 5 such as a keyboard and mouse. The display 4 and the input device 5 may be integrally formed as a touch panel display.

The image processing device 1 performs processing operations to visualize a status of recognition of a detection target when performing an image recognition operation that uses a machine learning model for detecting a predetermined event from a captured image. A result of visualization is presented to a user so that the user can visually check a validity of the machine learning model. In the present embodiment, the image processing device 1 is configured to evaluate the recognition performance of a machine learning model with images captured under various conditions caused by environmental changes; that is, to allow a user to check whether or not the robustness of an image recognition operation that uses a machine learning model, against various possible environmental changes is sufficient.

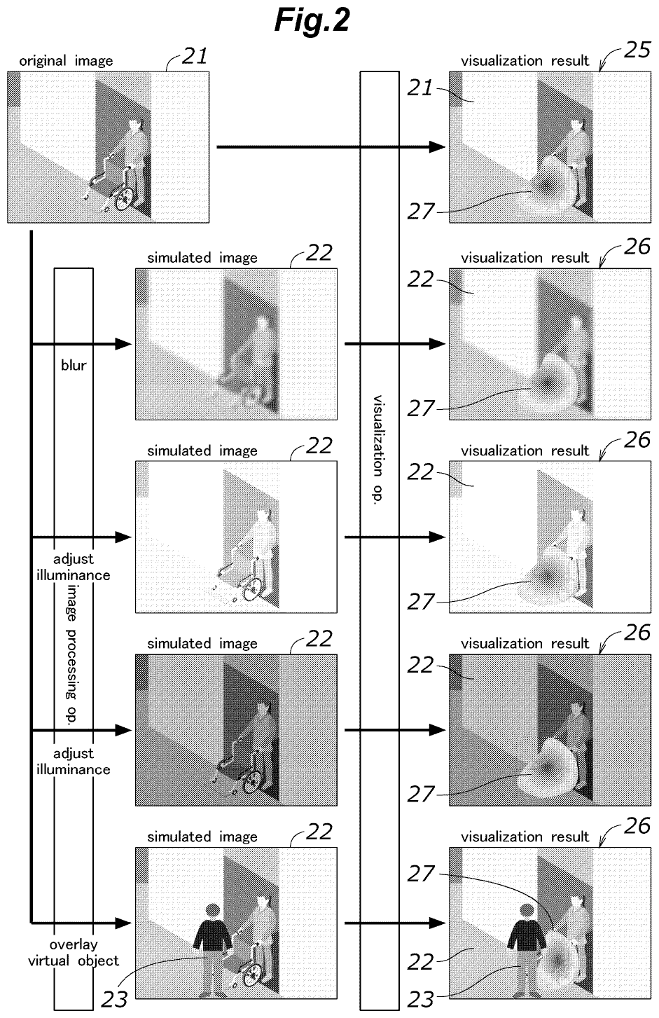

Next, processing operations performed by the image processing device 1 will be described. FIG. 2 is an explanatory diagram showing an outline of operations performed by the image processing device.

The image processing device 1 acquires an original image 21 (original captured image) from the camera 2 or the recorder 3. In this example, a monitored area (an area captured by the camera 2) is an elevator hall (a space used by persons to get in and out of an elevator). In addition, in this example, a detection target is a wheelchair, and the original image 21 shows a person exiting an elevator while moving the wheelchair.

The image processing device 1 performs an image processing operation on the original image 21 to generate a simulated image that reproduces an image captured in a specific situation. In response to a user's operation to designate an image processing condition, the image processing device 1 performs the image processing operation according to the designated image processing condition. In other words, based on possible environmental changes in the monitored area, the user designates a specific image processing condition, i.e., a set of various parameters of the image processing operation.

In the present embodiment, the image processing operations performed by the image processing device 1 include a blurring operation, an illuminance adjusting operation, and a virtual object overlaying operation.

In the blurring operation, a blurred image transformation is applied to the original image 21 to generate a simulated image 22 that reproduces a captured image in which blurring has occurred. Specifically, the image processing device 1 generates a simulated image 22 that reproduces an image captured when the camera lens is fogged up or an image captured when there is a fog out of doors.

In the illuminance adjusting operation, an image transformation that changes the brightness is applied to the original image 21 to generate a simulated image that reproduces an image captured under low and high illuminance conditions. Specifically, when the illuminance is set to high, the image processing device 1 generates a simulated image that reproduces an image captured under strong sunlight. Conversely, when the illuminance is set low, the image processing device 1 generates a simulated image that reproduces an image taken under low sunlight and with lighting devices unlit.

In the virtual object overlaying operation, a predetermined virtual object image 23 is overlaid on the original image 21. In this example, an image of a person is overlaid on the original image 21 as a virtual object image 23. When the virtual object image 23 is a person image, a simulated image is generated to represent a situation of a monitored area in which the monitored area is crowded with persons (the presence of a plurality of persons in the monitored area), or to represent a situation of the monitored area in which an object as a detection target is hidden by another object. The image processing device 1 creates a virtual object image 23 by cutting out a region of an object (such as a person) from an image previously captured by the camera 2. In some cases, the virtual object image 23 may be generated by using computer graphics (CG). The virtual object image 23 may be a silhouette image.

In the present embodiment, the image processing device 1 performs the blurring operation, the illuminance adjusting operation, and the virtual object overlaying operation as the image processing operations. In some cases, the image processing device 1 performs any other operations than the above described three operations as the image processing operations. For example, the image processing device 1 may perform an operation to change a resolution of an image. Furthermore, application software for image editing may be activated to allow the image processing device 1 to perform various image processing operations in response to user's operations on the screen.

The image processing device 1 performs a visualization operation to visualize a status of a detection target, when performing the image recognition operation that uses a machine learning model on a subject image (original image 21, simulated image 22). In the present embodiment, the image processing device 1 generates a result of visualization 25, 26 (result image), in which a heat map 27 (status image) representing a status of recognition of the detection target is overlaid on the subject image (original image 21, simulated image 22).

A heat map 27 is a tone image in which a color tone (hue) at each part (a pixel unit, or a block unit including a plurality of pixels) of a subject image (original image 21, simulated image 22) represents a degree to which the each part accounts for a recognition result indicating an object detected in the image recognition operation (hereafter also referred to as “contribution degree” of each part). More specifically, the heat map 27 is a tone image in which a color tone (hue) at each part of the subject image gradually changes depending on the contribution degree of the part. For example, the color tone (hue) is changed in the order of red, yellow, green, and blue with the decreasing contribution degree. In other cases, the heat map 27 may be a monochromatic image in which a level of brightness (density) at each part of a subject image represents the contribution degree of the part.

By comparing an image of an object, which is a detection target, in a subject image (original image 21, simulated image 22) with a heat map 27 overlaid on the subject image, a user can visually check the degree of overlap (consistency) between the two images. More specifically, a user can visually determine whether or not an area with a high contribution degree in a heat map 27 is located in the center of an image of an object, i.e., a detection target, to thereby check the accuracy of a recognition result of the image recognition operation, i.e., the validity of the machine learning model.

In the present embodiment, a heat map 27 overlaid on a subject image (original image 21, simulated image 22) is used to visualize a status of a detection target, when performing the image recognition operation that uses a machine learning model on a subject image (original image 21, simulated image 22). However, visual expressions used for the visualization are not limited to the heat map 27.

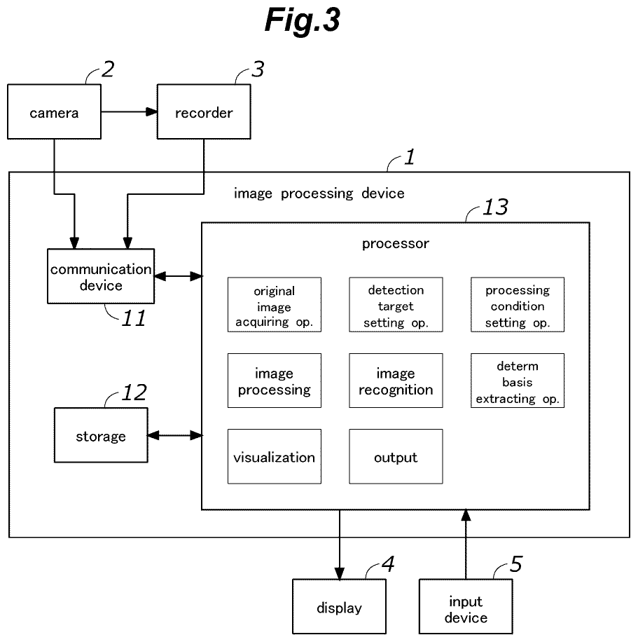

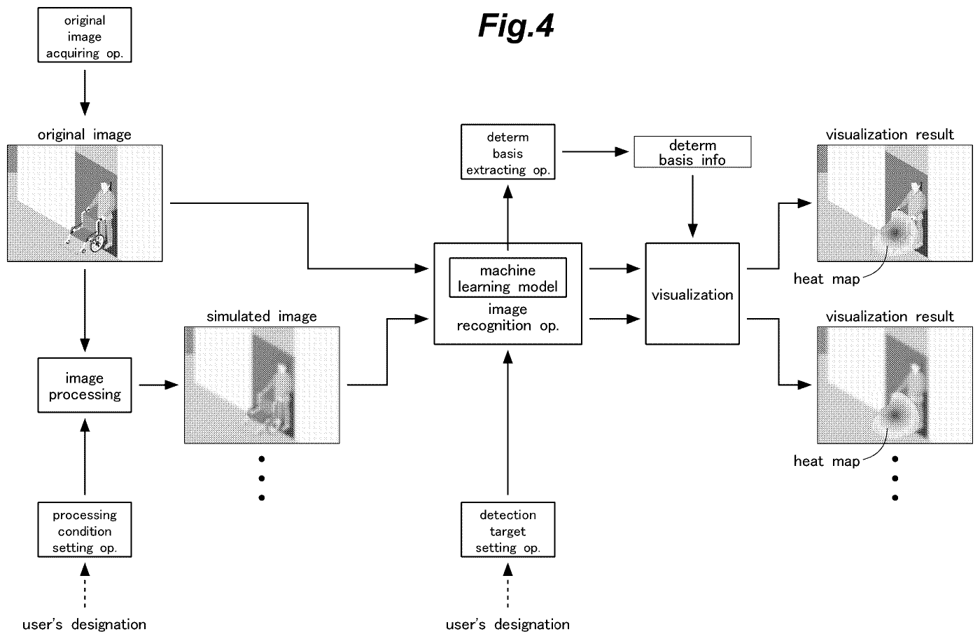

Next, the image processing device 1 will be described. FIG. 3 is a block diagram showing a schematic configuration of an image processing device 1, and FIG. 4 is a block diagram showing an outline of operations performed by the image processing device 1.

The image processing device 1 includes a communication device 11, a storage 12, and a processor 13.

The communication device 11 communicates with a camera 2 and a recorder 3.

The storage 12 stores programs that are executable by the processor 13 and other data.

The processor 13 performs various processing operations by executing programs stored in the storage 12. In the present embodiment, the processor 13 performs an original image acquiring operation, a detection target setting operation, an image processing condition setting operation, an image processing operation, an image recognition operation, a determination basis extracting operation, a visualization operation, an output operation, and other processing operations.

In the original image acquiring operation, the processor 13 acquires a captured image (original image) received from the camera 2 or the recorder 3 through the communication device 11.

In the detection target setting operation, in response to a user's operation, the processor 13 sets a type of an object (the type of object is a condition for the image recognition operation.) as a detection target for the image recognition operation that uses the machine learning model. In this operation, the processor 13 may also set, in addition to the object type as a detection target, a state of an object (object state) as a condition of the detection target. Specifically, the processor 13 may set a specific object in a specific state (e.g., a person in a state of fall) as a detection target.

In the image processing condition setting operation, the processor 13 sets an image processing condition (a condition for the image processing operation) according to a user's operation.

In the image processing operation, the processor 13 processes an original image to generate a simulated image based on the image processing condition set in the image processing condition setting operation. Specifically, the processor 13 performs the blurring operation, the illuminance adjusting operation, and/or the virtual object overlaying operation as the image processing operation (see FIG. 2).

In the image recognition operation, the processor 13 recognizes an object that is a detection target set in the detection target setting operation from a subject image (an original image, and a simulated image), by using a machine learning model (image recognition engine).

In the determination basis extracting operation, the processor 13 extracts determination basis information from the machine learning model used in the image recognition operation. Specifically, the processor 13 extracts the determination basis information contained in intermediate layers of a neural network that constitute the machine learning model. The determination basis information is information on a basis for determinations made by the machine learning model to produce a recognition result of the image recognition operation for a subject image (original image, simulated image); that is, information indicating a status of recognition of a detection target in the image recognition operation on the subject image.

In the visualization operation, the processor 13 generates a heat map that visualizes the determination basis information, and overlays the heat map on the subject image (original image and simulated image) to generate display information including a result of visualization (result image) (see FIG. 2). In addition to the machine learning model used for the image recognition operation, another machine learning model may also be used for the visualization operation.

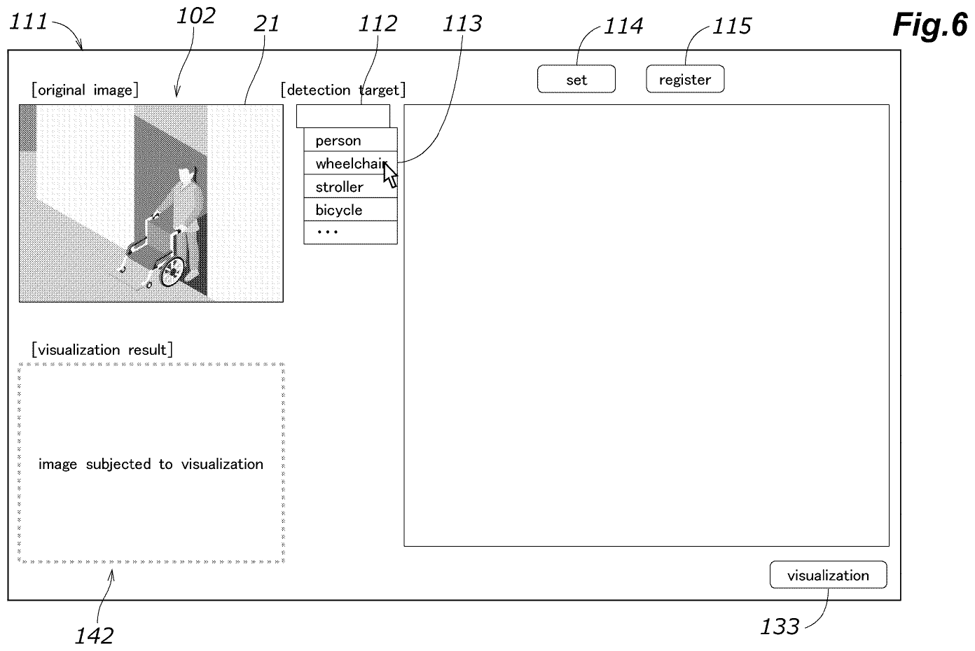

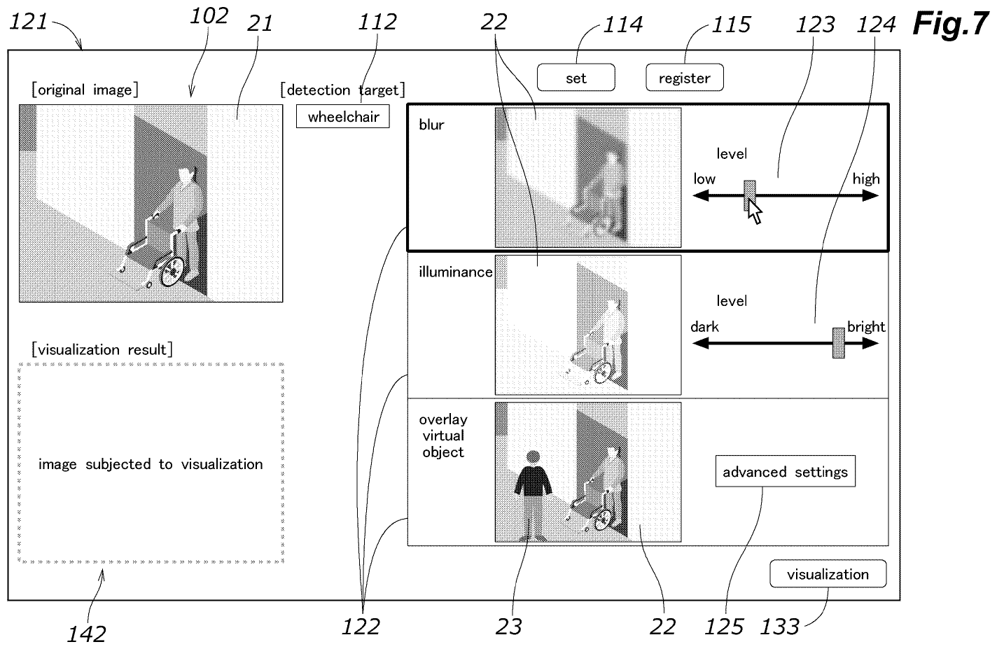

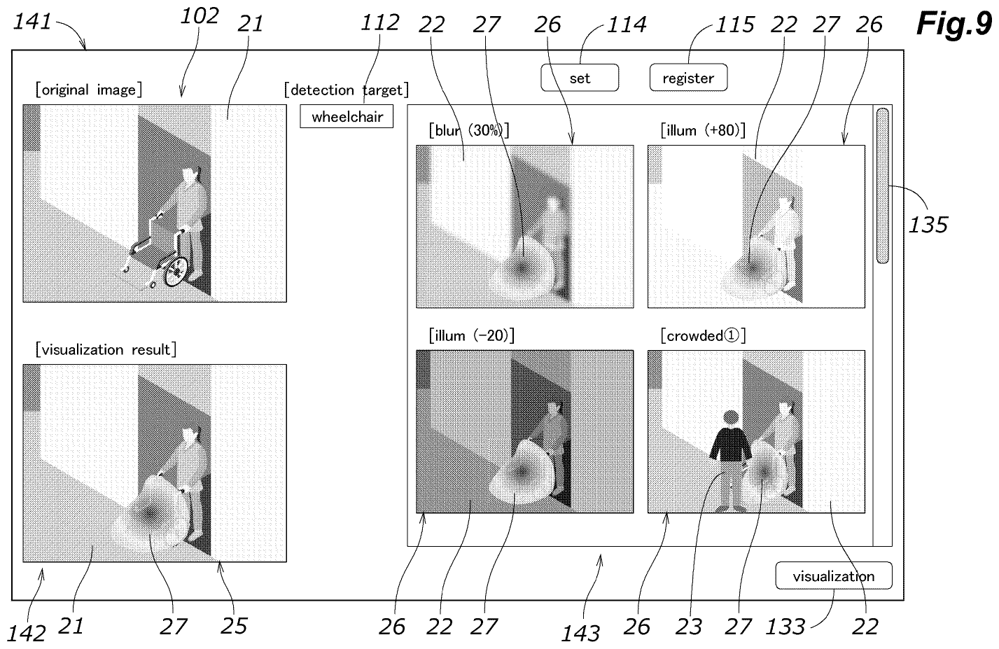

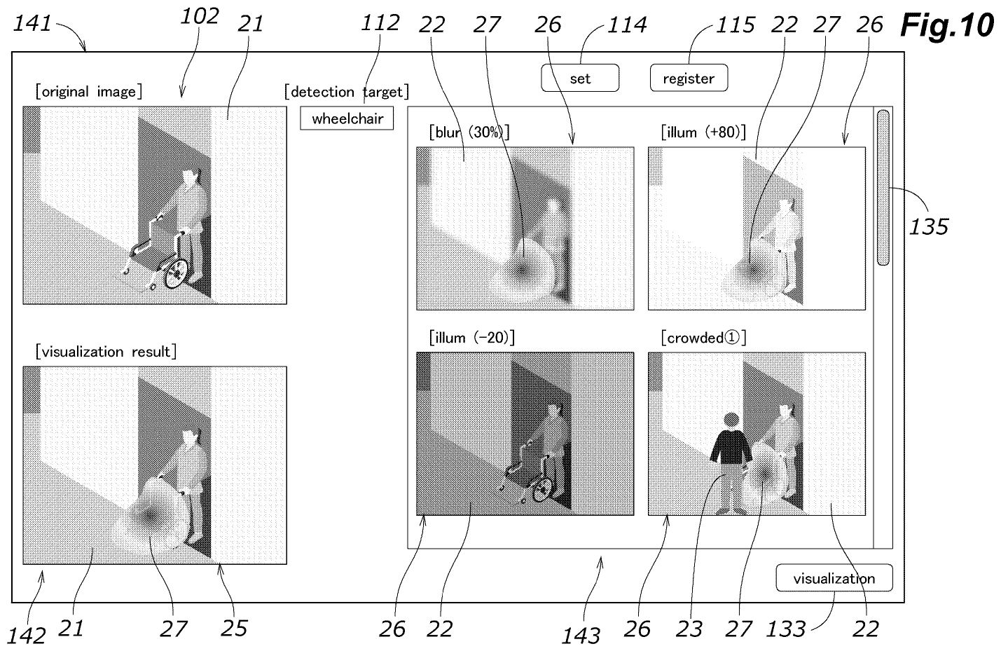

In the output operation, the processor 13 outputs display information to display screens including a detection target setting screen (FIG. 6) that allows a user to designate a detection target, an image processing condition setting screen (FIG. 7) that allows a user to designate an image processing condition, and a visualization result screen (FIGS. 9 and 10) that presents a result of visualization to a user.

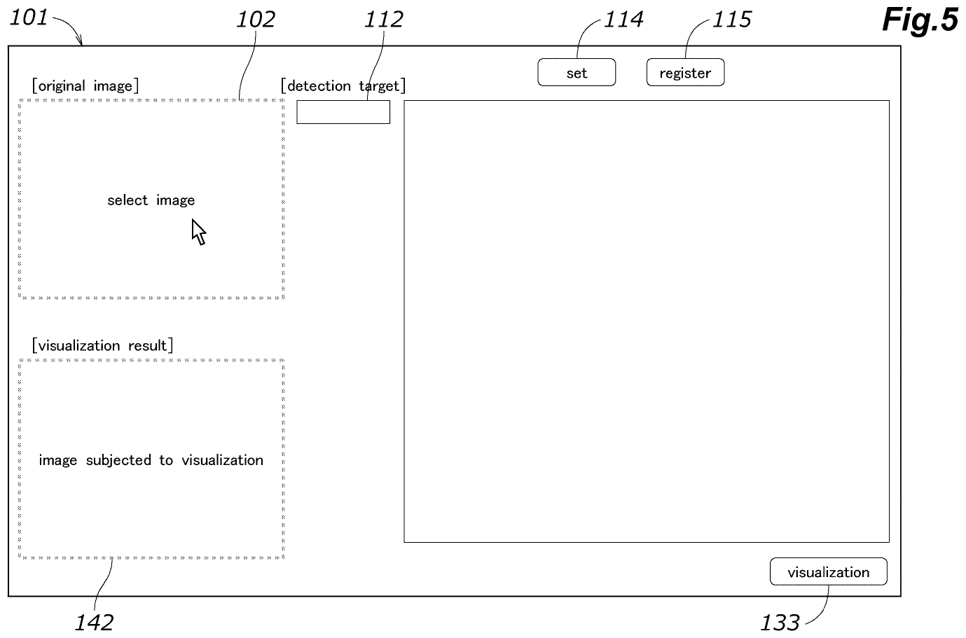

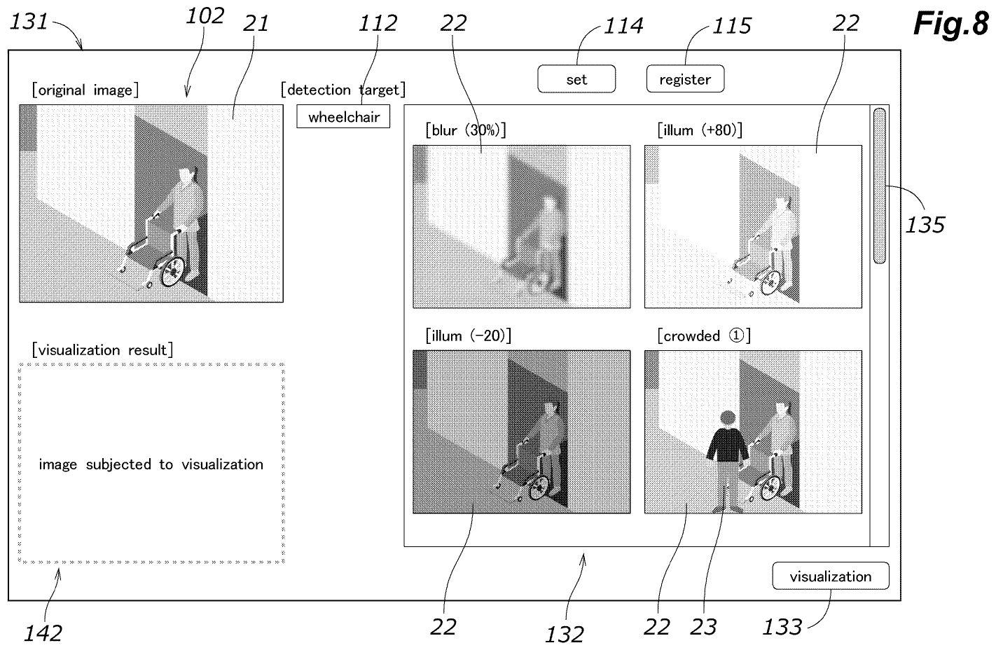

Next, screens displayed on the display 4 will be described. FIG. 5 is an explanatory diagram showing an original image setting screen. FIG. 6 is an explanatory diagram showing a detection target setting screen. FIG. 7 is an explanatory diagram showing a processing condition setting screen. FIG. 8 is an explanatory diagram showing a simulated image display screen. FIGS. 9 and 10 are explanatory diagrams showing a visualization result screen.

The original image setting screen 101 shown in FIG. 5 has an original image display section 102. When a user operates the original image display section 102, the display indicates an original image selection screen (not shown). The original image selection screen allows the user to select a file of a captured image stored in the recorder 3. As a result, the selected image stored in the recorder 3 is provided to the image processing device 1 as an original image. The original image selection screen also allows the user to select a camera 2. As a result, a real-time image output from the camera 2 is provided to the image processing device 1 as an original image. When the original image is input to the image processing device 1, the screen transitions to the detection target setting screen 111 (FIG. 6).

In the detection target setting screen 111 shown in FIG. 6, the original image 21 input to the image processing device 1 is displayed in the original image display section 102.

The detection target setting screen 111 has a detection target designation section 112. When a user operates the detection target designation section 112, a detection target list 113 is displayed, which allows the user to select a detection target from the detection target list. In this example, the user can select a person, a wheelchair, a stroller, a bicycle or any other object as a detection target(s).

The detection target setting screen 111 has a “set” button 114 and a “register” button 115 for registration. When a user operates the “set” button 114, the screen transitions to the image processing condition setting screen 121 (FIG. 7).

The image processing condition setting screen 121 shown in FIG. 7 has image processing condition sections 122 for different types of image processing operations. In this example, the image processing condition sections 122 are provided for three types of image processing operations, i.e., the blurring operation, the illuminance adjusting operation, and the virtual object overlaying operation.

The image processing condition sections 122 allows the user to designate an image processing condition. Upon receiving the user's designation, the image processing device 1 performs an image processing operation based on the designated image processing condition to display a simulated image 22 subject to the image processing operation in a corresponding image processing condition section 122. The user can make a visual check of the simulated image 22 to confirm whether or not a proper simulated image 22 is obtained through the image processing based on the designated image processing condition.

Specifically, the image processing condition section 122 for the blurring operation includes a level adjust section 123. The level adjust section 123 allows a user to adjust the level (degree) of blurring.

The image processing condition section 122 corresponding to the illuminance adjusting operation includes a level adjust section 124. The level adjust section 124 allows a user to adjust the level of illuminance (adjust brightness).

The image processing condition section 122 corresponding to the virtual object overlaying operation includes an “advanced settings” button 125. When a user operates the “advanced settings” button 125, the display indicates an image edit screen (not shown). The image edit screen allows the user to perform image editing to overlay a predetermined virtual object image 23 (such as a person image) on the original image 21.

The virtual object image 23 may be an image extracted from images captured by the camera 2 beforehand. The virtual object image 23 may be an image generated by computer graphics. The image edit screen (not shown) allows a user to operate the screen to adjust the position and size of the virtual object image 23 when overlaying the virtual object image 23 on the original image 21. Furthermore, when the virtual object image 23 is generated by CG using a 3D model, a user is allowed to operate the screen to adjust the orientation of the virtual object when overlaying the virtual object image 23 on the original image 21.

The user operates an image processing condition section 122 to designate a corresponding image processing condition, which allows the user to make a visual check of a simulated image 22 displayed in the image processing condition section 122 to confirm whether a proper simulated image 22 is obtained through the image processing based on the designated image processing condition. Upon the confirmation, the user operates the “register” button 115 to thereby register the simulated image 22 generated by the image processing based on the designated image processing condition, which causes the screen to transition to the simulated image display screen 131 (FIG. 8).

The simulated image display screen 131 shown in FIG. 8 has a simulated image display section 132. The simulated image display section 132 displays a simulated image 22 generated by the image processing based on the designated image processing condition. The simulated image display section 132 includes a scroll bar 135. By manipulating the scroll bar 135, the user can show an offscreen part of the simulated image 22.

When the user operates the “set” button 114, the screen returns to the image processing condition setting screen 121 (FIG. 7). Then, the user designates a different image processing condition and operates the “register” button 115 to thereby register a simulated image 22 representing a different condition. By repeating the above operations for registration, the user can register a plurality of simulated images representing different conditions. In this example, the simulated images to be registerable are a simulated image 22 representing a blurred condition generated by the blurring operation, a simulated image 22 representing a strong or weak sunlight condition (i.e., high or low illuminance condition) generated by the illuminance adjusting operation, and a simulated image 22 representing a crowded condition generated by the virtual object overlaying operation.

The simulated image display screen 131 has a “visualization” button 133. After completion of the registration of the required simulated images 22, a user operates the “visualization” button 133 to cause the processor 13 to perform the image recognition operation, the determination basis extracting operation, and the visualization operation, whereby the screen transitions to the visualization result screen 141 (see FIG. 9).

The visualization result screen 141 shown in FIG. 9 has a heat-mapped original image section 142. The heat-mapped original image section 142 displays a result of visualization 25 based on an original image 21. The result of visualization 25 is an image in which a heat map 27 is overlaid on the original image 21, the heat map 27 being a visualization of a basis for determinations made by a machine learning model to produce a recognition result of the image recognition operation for the original image 21.

The visualization result screen 141 has a heat-mapped simulated image section 143. The heat-mapped simulated image section 143 displays results of visualization 26 based on simulated images 22. Each result of visualization 26 is an image in which a heat map 27 is overlaid on the original image 21, the heat map 27 being a visualization of a basis for determinations made by a machine learning model to produce a recognition result of the image recognition operation for the simulated image 22.

Then, the user can make a visual check of the result of visualization 25 displayed in the heat-mapped original image section 142 and the results of visualization 26 displayed in the heat-mapped simulated image section 143 to determine whether or not the image recognition operation using a machine learning model is properly performed.

The visualization result screen 141 shown in FIG. 9 is an example of when there is no problem with robustness to environmental changes. In the visualization result screen 141 in FIG. 9, the heat-mapped simulated image section 143 shows that the results of visualization 26 for all the simulated images 22 indicate proper respective heat maps 27.

The visualization result screen 141 shown in FIG. 10 is an example of when there is a problem with robustness to environmental changes. In the visualization result screen 141 in FIG. 10, the heat-mapped simulated image section 143 shows that some of the results of visualization 26 for the simulated images 22 fail to show heat maps 27 (see the result for “illuminance-20”). In this example, the result of visualization 26 of the simulated image 22 that reproduces an image captured under low illuminance condition fail to include a heat map 27. As this result of visualization shows that the recognition accuracy is reduced in low illuminance situations, a user can confirm that there is a problem with recognition accuracy in low illuminance situations. In this case, the user can additionally train the machine learning model with data of images captured under low illuminance situations to improve recognition accuracy in low illuminance situations, thereby improving the robustness of the machine learning model against environmental changes.

In this way, in the present embodiment, simulated images 22 which reproduce images captured in various situations are generated, and statuses of recognition of a detection target in these simulated images 22 are visualized into heat maps 27, which allows a user to visually check the validity of a machine learning model in various situations. When confirming that there is a problem with the recognition accuracy in a particular situation, the user can further train the machine learning model with data of images captured under the particular situation to thereby improve the robustness of the machine learning model against environmental changes.

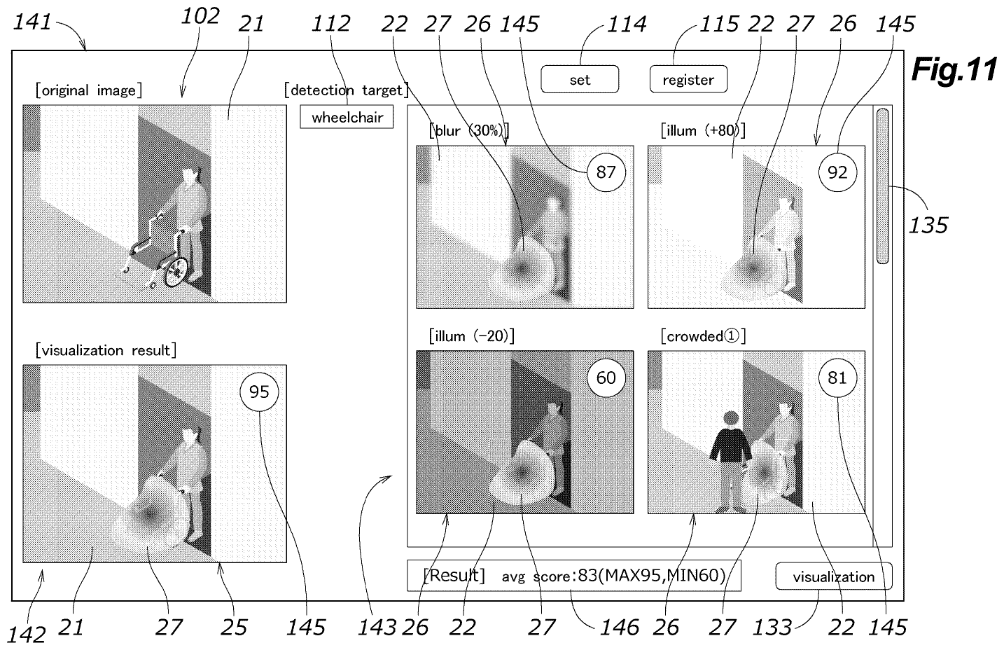

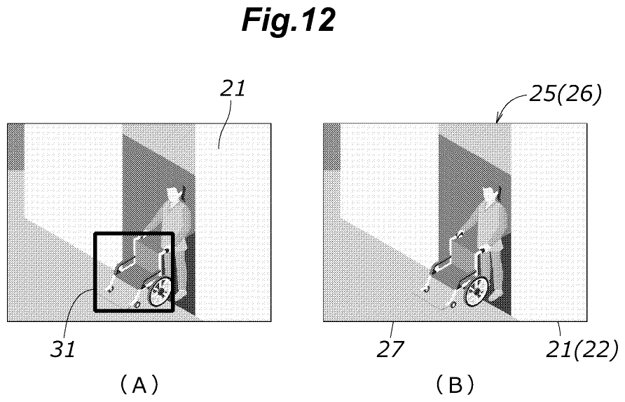

Next, another example of the visualization result screen will be described. FIG. 11 is an explanatory diagram showing the other example of the visualization result screen. FIG. 12 is an explanatory diagram showing a procedure for calculating a validity score.

In the visualization result screen 141 shown in FIG. 11, the heat-mapped original image section 142 and the heat-mapped simulated image section 143 display heat-mapped images, each including a validity score image 145 (status image) which indicates a validity score for the heat-mapped image. The validity score is a numerical expression of an accuracy of a status of recognition of a detection target in the image recognition operation for a subject image (original image 21, simulated image 22); that is, the validity score expresses a validity of a machine learning model for the subject image. In this example, a score image 145 is overlaid on each of the results of visualization 25, 26 for a subject image (original image 21, simulated image 22).

The visualization result screen 141 has a statistical information section 146. The statistical information section 146 displays statistical information about the validity scores of the simulated images 22. Specifically, the statistical information section 146 displays an average value (mean score), a highest value (MAX), and a lowest value (MIN) of validity scores of all the simulated images 22.

For the calculation of validity scores, a user preliminary sets a rectangular box 31 in an area occupied by a detection target in the original image 21, as shown in FIG. 12(A). This rectangular box 31 is entered by the user as annotation information. Specifically, the user visually determines and designates an area occupied by the detection target on the original image 21 displayed on the screen.

When calculating a validity score, as shown in FIG. 12(B), the processor 13 compares an area of a heat map 27 contained in a result of visualization 25, 26 for a subject image (original image 21, simulated image 22) with an area of a detection target (rectangular frame 31), and then calculates the validity score based on the degree of consistency (overlap rate) between the two areas. For example, when a displacement between the area of a heat map 27 and the area of the detection target (rectangular box 31) is small (i.e., the degree of consistency between the two areas is high), the validity score is high. When calculating a validity score, the processor 13 may reduce the weight of areas in a heat map 27 that have a low contribution to the recognition result.

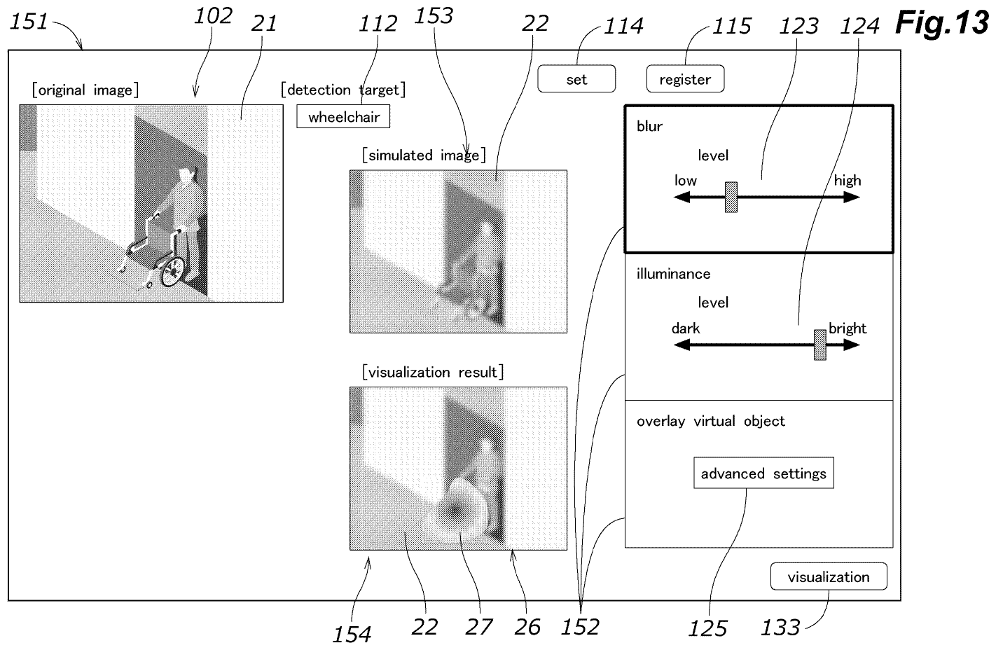

Next, a real-time visualization result screen shown in the display 4 will be described. FIG. 13 is an explanatory diagram showing the real-time visualization result screen. In the examples shown in FIGS. 7, 8, and 9, a user operates the image processing condition setting screen 121, designates an image processing condition for the image processing operation to generate a simulated image, and then operates the “visualization” button 133 on the simulated image display screen 131, whereby the screen transitions to the visualization result screen 141, in which results of visualization 25, 26 for a subject image (original image 21, simulated image 22) are displayed.

In the example shown in FIG. 13, in response to a user's operation to designate an image processing condition for the image processing operation for generation of simulated images, the real-time visualization result screen 151 shows simulated images 22 and a result of visualization 26 that reflect the designated image processing condition on a real-time basis.

The real-time visualization result screen 151 has image processing condition sections 152 for different types of image processing operations in a similar manner to the image processing condition setting screen (FIG. 7). Specifically, the image processing condition sections 152 are provided for the blurring operation, the illuminance adjusting operation, and the virtual object overlaying operation. The image processing condition section 152 allows a user to designate an image processing condition.

The real-time visualization result screen 151 has a simulated image display section 153. The simulated image display section 153 displays a simulated image 22 generated by the image processing operation based on the designated image processing condition such that the displayed simulated image 22 reflects a user's operation, if any, on the image processing condition sections 152.

The real-time visualization result screen 151 has a heat-mapped simulated image section 154. The heat-mapped simulated image section 154 displays results of visualization 26 based on the simulated image 22. Each result of visualization 26 is an image in which a heat map 27 is overlaid on a corresponding one of the simulated images 22, the heat map 27 being a visualization of a basis for determinations made by a machine learning model to produce a recognition result of the image recognition operation for the simulated image 22.

Then, the user can make a visual check of the simulated image 22 displayed in the simulated image display section 153 to confirm whether or not confirm whether or not a proper simulated image 22 is obtained through the image processing based on the designated image processing condition. Simultaneously, the user can make a visual check of the result of visualization 26 displayed in the heat-mapped simulated image section 154 to determine whether or not the image recognition operation using a machine learning model is properly performed.

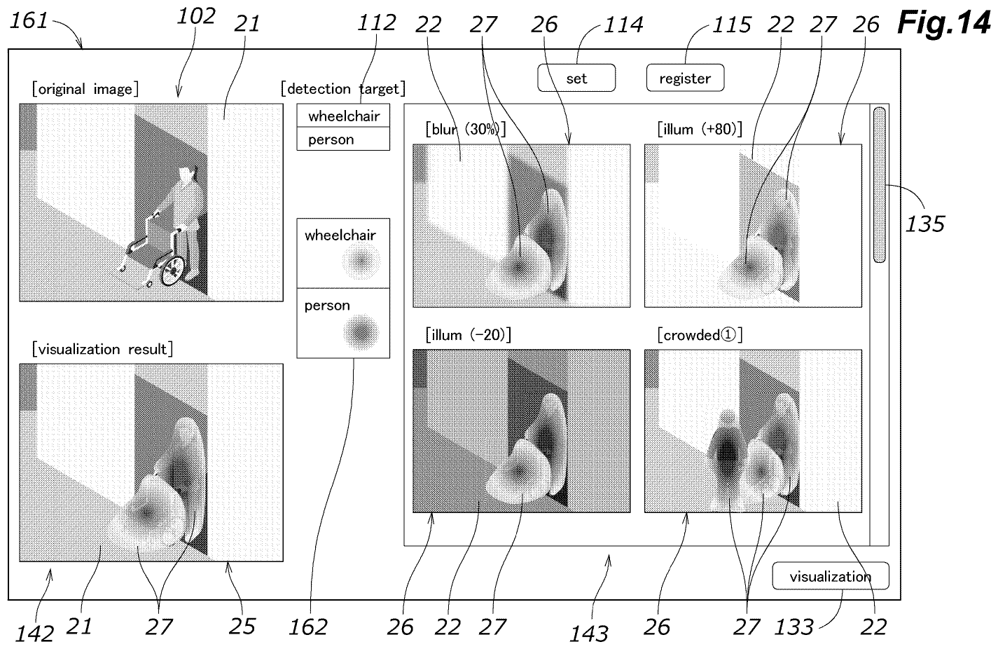

Next, the visualization result screen when a plurality of detection targets are designated will be described. FIG. 14 is an explanatory diagram showing the visualization result screen when a plurality of detection targets are designated.

The visualization result screen 161 shown in FIG. 14 allows a user to designate a plurality of detection targets in the detection target designation section 112.

In the visualization result screen 161, the heat-mapped original image section 142 displays a result of visualization 25, and the heat-mapped simulated image section 143 displays results of visualization 26. Each of all the results of visualization, i.e., each one of the result of visualization 25 and the results of visualization 26, includes a plurality of detection targets, for which the corresponding heat maps 27 are simultaneously displayed in different forms, specifically in different colors or patterns. In this example, two types of detection targets (wheelchair, person) are selected, and the heat map for one detection target may be displayed in a warm color and the heat map for the other detection target may be displayed in a cold color.

The visualization result screen 161 has a legend display section 162, as well as the heat-mapped simulated image section 143 and the heat-mapped original image section 142, the latter two sections displaying heat maps 27. The legend display section 162 allows a user to determine which one of the detection targets corresponds to each of the heat maps 27.

In this example, two types of objects (wheelchair and person) are selected as detection targets. However, three or more types of objects may be selected as detection targets.

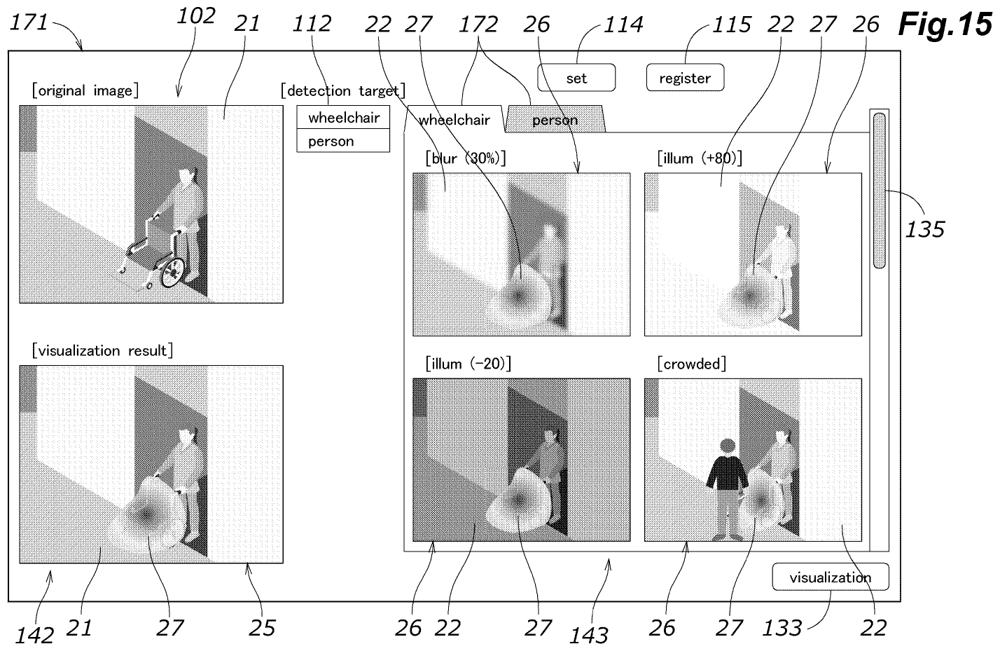

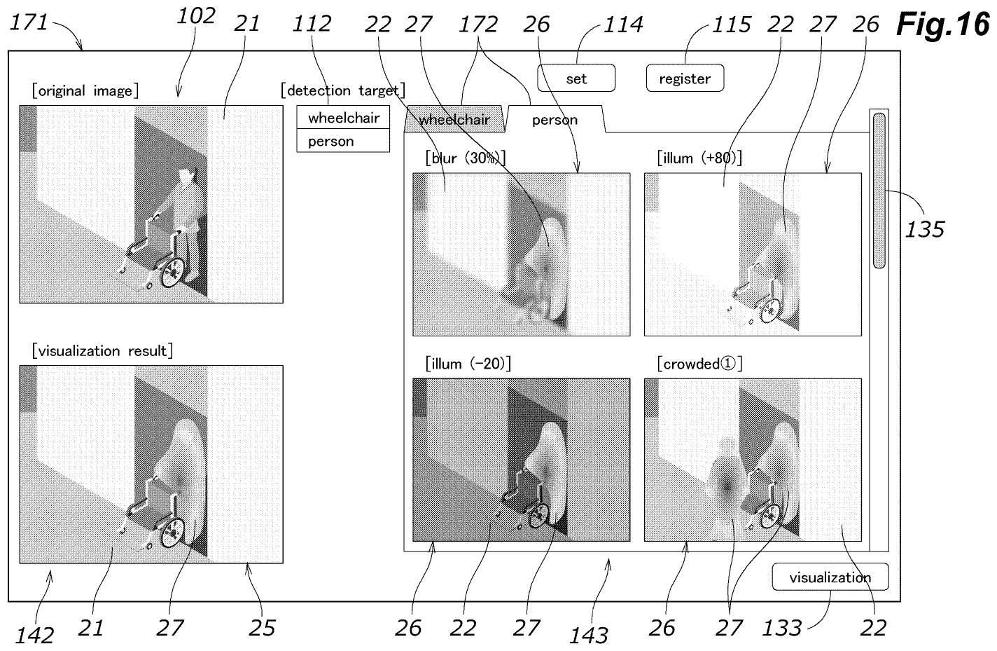

Next, a visualization result screen of a second example of when a plurality of detection targets are designated will be described. FIGS. 15 and 16 are explanatory diagrams showing visualization result screens of the second example of when a plurality of detection targets are designated.

FIGS. 15 and 16 show visualization result screens 171 each having tabs 172 for selecting one of different types of objects as a detection target. A user can operate the tabs 172 to switch the type of object to be a detection target so that the visualization result screen displays the results of visualization 26 for the selected detection target.

FIG. 15 shows a case where a user selects a wheelchair by operating the wheelchair tab 172, and a heat map 27 is overlaid on an area of the wheelchair in each simulated image 22 with a corresponding result of visualization 26. FIG. 16 shows another case where a user selects a person by operating the person tab 172, and a heat map 27 is overlaid on an area of the person in each simulated image 22 with a corresponding result of visualization 26.

The heat-mapped original image section 142 also displays a heat map 27 as a result of visualization 26 when a detection target is selected by a user's operation on a tab 172, in a similar manner to the heat-mapped simulated image section 143.

In this example, two types of objects (wheelchair and person) are selected as detection targets. However, three or more types of objects may be selected as detection targets. In such cases, the same number of tabs 172 as the types of detection targets are provided in the visualization result screen.

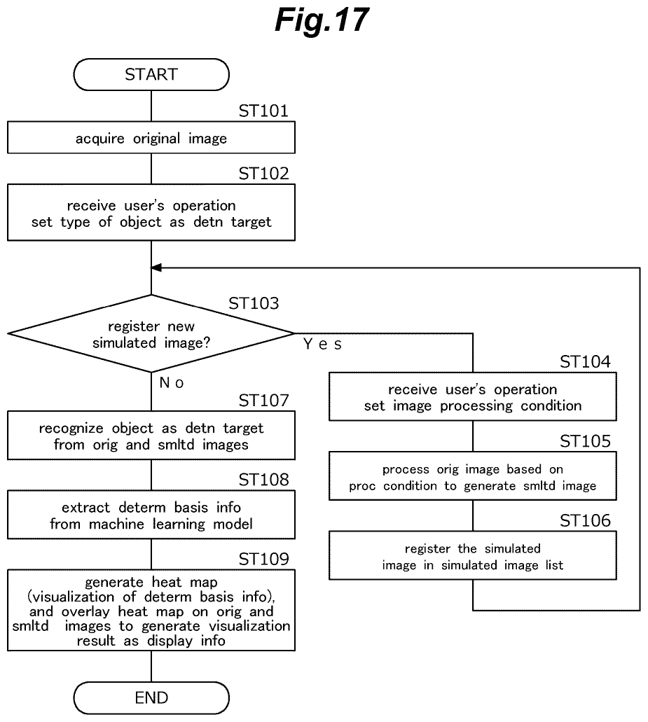

Next, a procedure of operations of the image processing device 1 will be described. FIG. 17 is a flow chart showing a procedure of operations of the image processing device 1.

The image processing device 1 first acquires an original image from the camera 2 or the recorder 3 (original image acquiring operation) (ST101).

Next, in response to a user's operation, the image processing device 1 sets the type of object to be a detection target in the image recognition operation that uses a machine learning model (detection target setting operation) (ST102).

Next, the image processing device 1 determines whether or not to proceed to new registration of a simulated image based on the user's operation (ST103). In this step, when the user operates the “set” button 114 on the image processing condition setting screen 121 (FIG. 7), the image processing device 1 proceeds to new registration of a simulated image. When the user operates the “visualization” button 133 on the simulated image display screen 131 (FIG. 8), the image processing device 1 does not proceed to new registration of a simulated image; that is, determines to terminate registration of the simulated image.

When proceeding to the new registration of a simulated image (Yes in ST103), the image processing device 1 sets an image processing condition (a condition for the image processing operation) in response to the user's operation (image processing condition setting operation) (ST104).

Next, the image processing device 1 processes the original image to generate a simulated image based on the image processing condition set in the image processing condition setting operation (image processing operation) (ST105).

Next, the image processing device 1 registers the simulated image generated by the image processing operation in a simulated image list (simulated image registration operation) (ST106), and then returns to ST103. In the step S106, in response to the user's operation of the “register” button 115 on the image processing condition setting screen 121 (FIG. 7), the image processing device 1 performs the simulated image registration operation.

In the other case, i.e., when the registration of the simulated image is terminated (No in ST103), the image processing device 1 uses a machine learning model (image recognition engine) to recognize an object as the detection target that is set in the detection target setting operation, from the original image and the simulated image (ST107).

Next, the image processing device 1 extracts determination basis information from the machine learning model used in the image recognition operation (determination basis extracting operation) (ST108).

Next, the image processing device 1 generates a heat map that visualizes the determination basis information, and then overlays the heat map on the original image and the simulated image to thereby generate a result image as a result of visualization, which is output as display information (visualization operation) (ST109).

While specific embodiments of the present disclosure are described herein for illustrative purposes, the present disclosure is not limited to those specific embodiments. Various changes, substitutions, additions, and omissions may be made to elements of the embodiments without departing from the scope of the invention. Moreover, elements and features of the different embodiments may be combined with each other to yield another embodiment of the present disclosure.

### INDUSTRIAL APPLICABILITY

An image processing device and an image processing method according to the present disclosure have an effect of enabling a system developer or a system administrator to easily and visually check robustness of a machine learning model against various possible environmental changes on site to thereby build a system with high robustness, and are useful as an image processing device and an image processing method in which, when an image recognition operation that uses a machine learning model is performed for detecting a predetermined event from a captured image, a status of recognition of a detection target is visualized and presented to a user so that the user can visually check image recognition performance of the machine learning model.

### Glossary

1 image processing device
2 camera
3 recorder
4 display
5 input device
11 communication device
12 storage
13 processor
21 original image
22 simulated image
23 virtual object image
25 result of visualization
26 result of visualization
27 heat map (status image)
31 rectangle box

1. An image processing device for performing processing operations to visualize a status of recognition of a detection target when performing an image recognition operation that uses a machine learning model for detecting a predetermined event from a captured image, wherein the processing operations are performed by a processor, and include:
in response to a user's operation to designate an image processing condition, performing an image processing operation on an original image based on the designated image processing condition to thereby generate a simulated image that reproduces an image captured in a specific situation; and
generating a status image that represents a status of recognition of a detection target, when performing the image recognition operation on the simulated image, and overlaying the generated status image on the simulated image to produce a result image as a result of visualization, which is output as display information.

2. The image processing device as claimed in claim 1, wherein the processing operations performed by the processor include:
presenting a detection target setting screen to the user, and
in response to the user's operation on the detection target setting screen, setting the detection target designated by the user.

3. The image processing device as claimed in claim 1, wherein the processing operations performed by the processor include:
presenting a processing condition setting screen to the user; and
in response to the user's operation on the processing condition setting screen, setting the image processing condition designated by the user.

4. The image processing device as claimed in claim 1, wherein the image processing operation includes at least one of a blurring operation, an illuminance adjusting operation, and a virtual object overlaying operation.

5. The image processing device as claimed in claim 1, wherein the processing operations performed by the processor include:
generating a tone image, in which a color tone at each part of the simulated image represents a contribution degree which is a degree to which the each part accounts for a recognition result of the image recognition operation; and
overlaying the tone image as the status image on the simulated image.

6. The image processing device as claimed in claim 1, wherein the processing operations performed by the processor include:
generating a score image indicating a score that numerically expresses an accuracy of the status of recognition of the detection target in the simulated image; and
overlaying the score image as the status image on the simulated image.

7. The image processing device as claimed in claim 1, wherein, when the user designates a plurality of detection targets, the processing operations performed by the processor include:
generating the status image for each of the plurality of detection targets such that the respective status images for the plurality of detection targets are shown in a visually distinguishable manner; and
overlaying the status images on the simulated image.

8. An image processing method for performing processing operations to visualize a status of recognition of a detection target when performing an image recognition operation that uses a machine learning model for detecting a predetermined event from a captured image, wherein the processing operations are performed by an information processing device, and the processing operations include:
in response to a user's operation to designate an image processing condition, performing an image processing operation on an original image based on the designated image processing condition to thereby generate a simulated image that reproduces an image captured in a specific situation; and
generating a status image that represents a status of recognition of a detection target when performing the image recognition operation on the simulated image, and overlaying the generated status image on the simulated image to produce a result image as a result of visualization, which is output as display information.
